(19) United States
(12) Patent Application Publication
(10) Pub. No.: US 2010/0161641 A1
(43) Pub. Date: Jun. 24, 2010

(54) SYSTEM AND METHOD FOR COMPUTERIZED SEARCHING WITH A COMMUNITY PERSPECTIVE

(75) Inventors: Steven Matt Gustafson, Schenectady, NY (US); Samit Paul, Bangalore (IN); Babu Ozhur Narayanan, Karnataka (IN); Vineel Chandrakanth Gujjar, Bangalore (IN); Jagannadan Varadarajan, Martigny (CH)

Correspondence Address: FLETCHER YODER P.C., 7915 FM 1960 RD. WEST, SUITE 330, HOUSTON, TX, 77070, US

(73) Assignee: NBC Universal, Inc., a New York Corporation, New York, NY (US)

(21) Appl. No.: 12/341,501

(22) Filed: Dec. 22, 2008

(51) Int. Cl. G06F 17/30

(52) U.S. Cl. 707/759; 707/E17.014; 707/E17.108

(57) ABSTRACT

A system and method for conducting a computerized search, including: receiving a user query, a perspective, and a term associated with the perspective; conducting a first search based on the user query; expanding the term to a list; analyzing the first search results based on the list; modifying the user query based on the analysis of the first search results; and conducting a second search based on the modified user query. Alternatively, a system and method for conducting a computerized search, including: receiving a user query; conducting a computerized search based on the user query to obtain first results; analyzing a knowledge base; generating a weighted context term vector based on the knowledge base, wherein the weighted context term vector includes context words; matching the first results with the weighted context term vector; and listing second results based on the match.

### BACKGROUND

The present invention relates generally to the field of computerized searching, and more particularly for providing computerized search results relevant to a given community.

Computerized searching via the Internet or Web, such as with Google™ or Yahoo!®, has become a daily activity for many. Such searches may be conducted for personal or business reasons. Unfortunately, many of the search results may not be relevant to the particular user.

### BRIEF DESCRIPTION

An aspect of the invention includes a method for conducting a computerized search, including: receiving a user query, a perspective, and a term associated with the perspective; conducting a first search based on the user query; expanding the term to a list; analyzing the first search results based on the list; modifying the user query based on the analysis of the first search results; and conducting a second search based on the modified user query.

An aspect of the invention includes a method for conducting a computerized search, including: receiving a user query; conducting a computerized search based on the user query to obtain first results; analyzing a knowledge base; generating a weighted context term vector based on the knowledge base, wherein the weighted context term vector comprises context words; matching the first results with the weighted context term vector; and listing second results based on the match.

An aspect of the invention includes a system for conducting a computerized search, including a server comprising executable code stored in memory, wherein the executable code is configured to: receive a user query, a perspective, and a term associated with the perspective; conduct a first search based on the user query; expand the term to a list; analyze the first search results based on the list; modify the user query based on the analysis of the first search results; and conducting a second search based on the modified user query.

An aspect of the invention includes a system for conducting a computerized search, including a server comprising executable code stored in memory, wherein the executable code is configured to: receive a user query; conduct a computerized search based on the user query to obtain first results; analyze a knowledge base; generate a weighted context term vector based on the knowledge base, wherein the weighted context term vector comprises context words; match the first results with the weighted context term vector; and listing second results based on the match.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a method for conducting a computerized search in accordance with aspects of the present invention; and

FIG. 2 is a block diagram of a method for conducting a computerized search in accordance with aspects of the present invention.

### DETAILED DESCRIPTION

The present technique provides for web search results more relevant to a given set of users (e.g., a web community). In particular, given a perspective and an associated term, a user query may be analyzed and modified to obtain search results more relevant to the user by serving out results from a search engine for the modified query. The technique facilitates biasing the results towards one out of several competing perspectives (e.g., male balding vs. female balding). For instance, if the community is one of women, and the associated term is “women,” given a user query such as “interview attire,” the technique may determine if “interview attire women” is a meaningful modified query that is likely to result in more relevant results. For an irrelevant query (e.g., Linux), the query may not be modified. Moreover, the technique may accomodate not only one perspective, but a set of perspectives and associated terms. For example, in a format of ((perspective, term)), the sets may include: ((female, women), (kids, children), (scientist, science)), etc. For each perspective or community, a representative term is employed. The system can be used to modify user queries for multiple communities.

In certain embodiments, given a user query, community, and associated term, initial search results (e.g., 100 results) are obtained from a web search engine such as Yahoo!® or Google™ based on the user query. The titles, snippets, and URL's for the results are collected. Then, the chosen term (e.g. female) associated with the community (e.g., women) is expanded to a list of synonyms (e.g., including plural forms). The term may also be expanded to a list of antonyms or words that capture a different perspective. For example, for a term like women, the associated list may be {women, woman, female, lady, ladies, woman's, women's} and the contrarian list {male, men, men's, man, gent}. Then the 100 aforementioned results are analyzed in real time for the presence of the associated terms and the contrarian terms. The analysis may involve counts summarized into a score using a formula, for example.

The score may determine whether it is appropriate to use the augmentation or not. For example, a term such as “interview attire” may yield search results for both men and women. In such a case, it may be determined that biasing the results by adding the term women to the query may improve search results quality for the community of women of interest. For a query such as pregnancy or linux, the score may turn out to be low, indicating that either the bias towards the community is already built into the search results or there is not need for a bias.

The technique may provide web search results for a user query that are relevant to the user community. The results may be provided by modifying the user query to capture the desired perspective. A list of perspectives (e.g., women, kids, women & health, etc.) along with a preassigned set of augmenting words (women OR female, kids OR children, women health) are also given. The technique may take as input a user query and a desired perspective, and the augmenting keyword, and may output the unmodified/modified query if appropriate. In one example, the user query is “interview attire.” The modified query may be “interview attire women OR female.” In another example, the user query is “period.” The modified query may be “period health” for a perspective or community of women. It should be noted that while the query may be modified if appropriate or desired, the query may remained unchanged. For example, if the user query if “linux,” it generally would not be modified as “linux women.”

Furthermore, the technique may also evaluate the search results via a knowledge base (e.g., a whitelist of a set of sites relevant to the perspective or community) to score for the competing perspectives. The scores may then combined into a decision system to determine if the associated term augmentation is meaningful. In sum, the technique may result in increased relevance of search results for the user. Business advantages may include creating a differentiated search offering, facilitating increased traffic, and increased revenue through search related advertising. In sum, the technique may provide more relevant search results by rewriting the user query by specific augmentations to resolve competing perspectives.

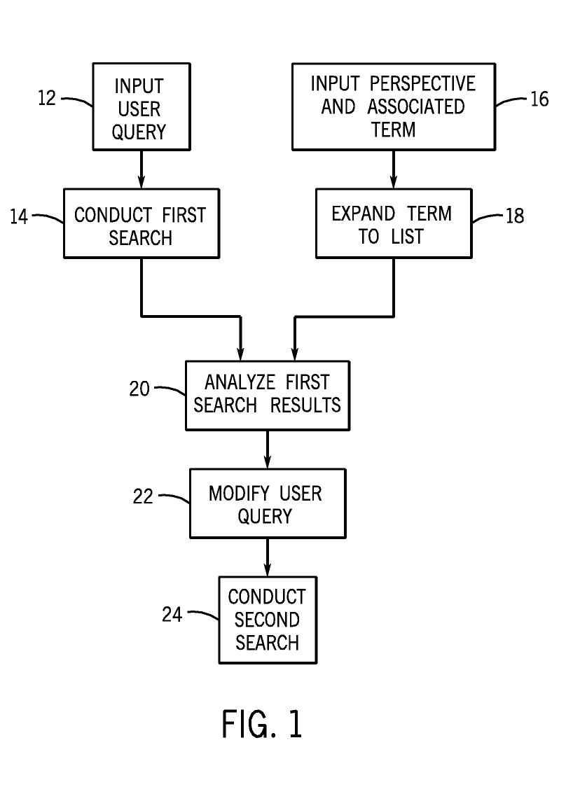

Referring to the drawings, FIG. 1 depicts a method 10 for conducting a computerized search. A user query is input or received (block 12). A first search is conducted based on the user query (block 14). A perspective (e.g., community) and a term associated with the perspective are also input or received (block 16). The associated term is expanded into a list of synonyms or antonyms, or a combination thereof (block 18). Further, the first search results are analyzed for the presence of the synonyms and antonyms, and a score may be generated to determine if the original user query should be modified (e.g., rewritten or augmented with a pre-assigned word or term) (block 20). After the analysis, the user query is modified (block 22) (e.g., adding a term or terms to the user query), and a second search is conducted which may provide relevant results via the modified user query (block 24). The technique is unique in that it performs query rewriting to capture the perspective of the community. It may be different from that of a vertical search, for example, in that with the present technique, search results may be provided from the entire web by rewriting the query to capture the community perspective.

Lastly, it should be noted that a perspective and/or term (block 16) may received as output from the analysis of the first search results (block 20), such as in a dynamic case. The perspective and/or term may be received from a non-user rule set, such as in a fixed case. In part, block 16 could function as a business rule globally defining the perspective of most or all searches. However, the associative term of block 16 may be derived from the inputted user query (block 12) and a knowledge base, for example. Likewise, the expansion of the term to a list (block 18) may be based on the inputted user query (block 12) and a knowledge base. It should be apparent that a variety of sources and schemes may supply the perspective and associated term, and contribute to the expansion of the term.

Moreover, in another aspect of the technique, the query may not be rewritten. Instead, a search is conducted based on the user query and then relevant search results are selected for listing or display to the user. The challenge may remain to provide web search results relevant to a community. For example, a query such as polish may typically mean nail or boot polish as opposed to the polish language. In certain embodiments, the problem resolved may be to display the search results that are more likely to be relevant at the top of the results page by subselecting (e.g., from the top 100 results from an engine such as Google or Yahoo) those that are relevant and display them at the beginning of the search results. In certain embodiments, for a given user query, a weighted context term vector is generated in real time by analyzing a knowledge base. This knowledge base may be a list of web pages or other documents, for example. The top results (e.g., top 100 results) for the user query may be obtained by using an engine such as Google or Yahoo. Each result (e.g., including snippet, title, URL, etc.) may be matched for similarity to the weighted context term vector using a similarity or statistical measure, such as Cosine distance. Results that score highly (e.g., using a threshold computed in real time) are subselected for display as they are likely to be most interesting to the user.

As an example, if a user query “highlights,” such as on a web site (e.g., iVillage) directed to a women community, a weighted context term vector consisting of words such as hair, style, color, etc., may be obtained. Then, the search engine results related to hair highlights will be subselected. Results such as those relating to news, sports highlights, and so on, may be dropped. Features of the technique may include real time generation of context terms, similarity measure to detect contextual relevance of search engine results, and subsetting of search engine results based on dynamically chosen threshold. Further, it should be noted that a given community may be defined by or encompass a variety of formats. For example, a community may be visitors to a given web site (e.g., iVillage.com), visitors to a personal website (e.g., Linekdin or Facebook), readers on a particular blog, or any implicitly defined community, and so on. Competitive advantages may include better contextual web search product, resulting in increased traffic and usage of the particular web search, and hence increased search related revenue. In sum, the technique may provide for a novel method and system for contextual/perspective search. It should be noted that the searches discussed herein may be conducted from a personal computer, mobile computer or laptop, personal digital assistant (PDA), cell phone, other appliances, and so on.

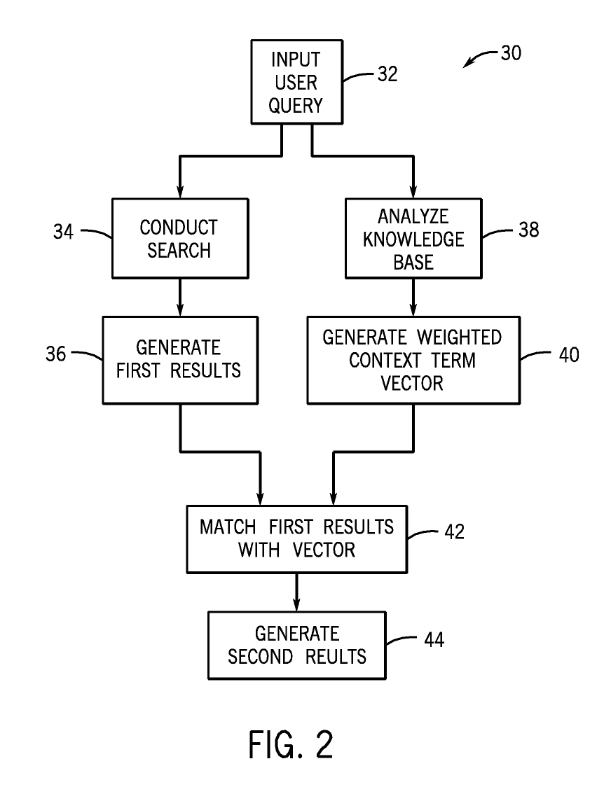

FIG. 2 depicts a method 30 for conducting a computerized search. A user query is input or received (block 32). A search is conducted based on the user query (block 34) and first results are generated (block 36). Further, a knowledge base is analyzed (block 38) and a weighted context term vector is generated (block 40) based on the user query and the knowledge base. Again, a knowledge base may be a database or a list of web pages or other documents, for example. The first results are matched for similarity to the weighted context term vector using a similarity or statistical measure, for example (block 42). Results that score highly (e.g., using a threshold computed in real time) are subselected for display as they are likely to be most relevant or interesting to the user (block 44). Concepts, perspective, etc. may be determined from the results returned, and from a knowledge base and potential queries within.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for conducting a computerized search, comprising:
receiving at a processor a user query, a perspective, and a term associated with the perspective;
conducting via the processor a first search based on the user query;
expanding via the processor the term to a list;
analyzing via the processor the first search results based on the list;
modifying via the processor the user query based on the analysis of the first search results; and
conducting via the processor a second search based on the modified user query.

2. The method of claim 1, wherein results of the second search are biased toward the perspective.

3. The method of claim 1, wherein the perspective comprises a web community.

4. The method of claim 1, wherein modifying the user query comprises augmenting the user query.

5. The method of claim 1, wherein receiving a perspective comprises receiving a plurality of perspectives, and receiving a term comprises receiving a plurality of terms associated respectively with the plurality of perspectives.

6. The method of claim 1, wherein expanding the term comprises identifying at least one synonym of the term or at least one antonym of the term, or a combination thereof.

7. The method of claim 1, wherein the expanded term comprises the term, and at least one synonym of the term or at least one antonym of the term, or a combination thereof.

8. The method of claim 1, wherein analyzing the first search results comprises analyzing the first search results in substantially real time for the presence of the synonym (associated terms) and the antonym (contrarian terms).

9. The method of claim 1, wherein analyzing the first search results comprises analyzing the first search results in substantially real time for the presence of the synonym (associated terms) and the antonym (contrarian terms), or a combination thereof.

10. The method of claim 9, comprising summarizing via the processor the presence of the synonym or the antonym, or a combination thereof, into a score using a formula.

11. The method of claim 10, wherein modifying the user query comprises augmenting the user query with the term or other preassigned word associated with the perspective.

12. The method of claim 10, wherein analyzing the first search results comprises evaluating the first search results based on a knowledge base to score competing perspectives.

13. The method of claim 10, comprising combining scores into a decision system to determine if augmentation of the user query with an associated term is meaningful.

14. A method for conducting a computerized search, comprising:
receiving via a processor a user query;
conducting via the processor a computerized search based on the user query to obtain first results;
analyzing via the processor a knowledge base;
generating via the processor a weighted context term vector based on the knowledge base, wherein the weighted context term vector comprises context words;
matching via the processor the first results with the weighted context term vector; and
listing via the processor second results based on the match.

15. The method of of claim 14, wherein generating the context term vector, matching the first results with the weighted context term vector, and listing the second results are performed automatically in substantially real time.

16. The method of of claim 14, wherein listing second results based on the match comprises selecting and displaying first results that are contextually relevant based on a dynamically chosen threshold of the match.

17. The method of of claim 14, wherein generating the weighted context term vector comprises generating the weighted context term vector in substantially real time.

18. The method of of claim 14, wherein matching comprises matching the first results with the weighted context term vector using a similarity measure.

19. The method of claim 17, wherein the similarly measure comprises cosine distance.

20. A system for conducting a computerized search, comprising:
a server comprising executable code stored in memory, wherein the executable code is configured to:
receive a user query, a perspective, and a term associated with the perspective;
conduct a first search based on the user query;
expand the term to a list;
analyze the first search results based on the list;
modify the user query based on the analysis of the first search results; and
conducting a second search based on the modified user query.

21. A system for conducting a computerized search, comprising:
a server comprising executable code stored in memory, wherein the executable code is configured to:
receive a user query;
conduct a computerized search based on the user query to obtain first results;
analyze a knowledge base;
generate a weighted context term vector based on the knowledge base,
wherein the weighted context term vector comprises context words;
match the first results with the weighted context term vector; and
listing second results based on the match.
